(19) United States
(12) Patent Application Publication
(10) Pub. No.: US 2009/0016218 A1
(43) Pub. Date: Jan. 15, 2009

(54) METHOD OF CONTROLLING DOWNSTREAM TRAFFIC FLOW IN CABLE NETWORK HEADEND

(75) Inventors: Seung Eun HONG, Daejeon (KR); Ho Jin Kwon, Seoul (KR); O Hyung Kwon, Daejeon (KR); Soo In Lee, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 11/947,519

(22) Filed: Nov. 29, 2007

(30) Foreign Application Priority Data
Dec. 6, 2006 (KR) 10-2006-122890
May 31, 2007 (KR) 10-2007-53337

(51) Int. Cl. H04L 12/56

(52) U.S. Cl. 370/231

(57) ABSTRACT

Provided is a method of controlling the flow of downstream traffic in a cable network headend. The method includes the steps of: establishing a session with the modulator; transferring traffic to the modulator over the session; and receiving a buffer-status reporting message reporting the status of a receive buffer from the modulator while transferring the traffic. The method reports buffer-status information of an Edge-Quadrature Amplitude Modulator (E-QAM) to a traffic source, thereby enabling control of the transfer rate of traffic transferred from the traffic source to the E-QAM and preventing overflow/underflow of a receive buffer, packet loss and deterioration of channel use.

### CROSS-REFERENCE TO RELATED APPLICATION

This application claims priority to and the benefit of Korean Patent Application No. 2006-122890, filed Dec. 6, 2006, and No. 2007-53337, filed May 31, 2007, the disclosure of which is incorporated herein by reference in its entirety.

### BACKGROUND

1. Field of the Invention

The present invention relates to a method of controlling the flow of downstream traffic in a headend of a cable network, and more particularly, to a method of controlling a downstream traffic flow by reporting the status of a receive buffer storing the traffic to a traffic source in a cable network headend.

The present invention has been produced from the work supported by the IT R&D program of MIC (Ministry of Information and Communication)/IITA (Institute for Information Technology Advancement) [2006-S-019-01, The Development of Digital Cable Transmission and Receive System for 1 Gbps Downstream] in Korea.

2. Discussion of Related Art

In recent times, services via cable networks have been developed to transmit not only data, but also various forms of traffic, such as voice and video, through a single quadrature amplitude modulator (QAM). Thus, cable networks that have mainly transmitted data traffic on the basis of a Data Over Cable Service Interface Specification (DOCSIS) protocol also perform voice and video traffic transmission based on an Internet Protocol (IP).

In conventional cable networks that have mainly transmitted data traffic, a headend serves as a repeater station connecting a common IP network, e.g., the Internet, with each cable modem. The headend comprises a Cable Modem Termination System (CMTS), and more specifically comprises an integrated CMTS mainly and synthetically performing functions of a Media Access Control (MAC) layer and a physical (PHY) layer.

However, along with demands on voice and video traffic transmission as well as data traffic transmission, a headend has been developed to have a Modularized-CMTS (M-CMTS) structure in which the function of a CMTS is modularized. The M-CMTS structure is manufactured by modularizing a conventional CMTS into an M-CMTS core serving as the MAC layer taking charge of DOCSIS MAC framing and an Edge-QAM (E-QAM) serving as the PHY layer taking charge of a DOCSIS PHY transmission function. Through the modularization, the E-QAM can receive traffic from a video server as well as the M-CMTS core, and can transfer the traffic to a user through a cable subscriber network.

FIG. 1 is a block diagram conceptually showing the structure of a headend in a cable network.

Referring to FIG. 1, an M-CMTS core 110 receives IP-based video traffic 111, IP-based data traffic 112, and IP-based voice traffic 113, performs DOCSIS-MAC-framing on the traffic, and transfers the same to the E-QAM 120. The M-CMTS core 110 and the E-QAM 120 are connected through a converged interconnect network (CIN) 130, generally consisting of a gigabit Ethernet.

In the CIN 130, the M-CMTS core 110 and the E-QAM 120 use a Downstream External PHY Interface (DEPI) 140 protocol based on Layer 2 Tunneling Protocol version 3 (L2TPv3), which is established for communication between the M-CMTS core 110 and the E-QAM 120 by Internet Engineering Task Force (IETF) Standardization Collaboration.

For broadcasting service and video service, the E-QAM 120 can be connected with a video server 150 through the CIN 130. In general, the video server 150 transfers a Moving Picture Experts Group (MPEG) 2-Transport Stream (TS)-based video traffic 160 to the E-QAM 120 using a User Datagram Protocol (UDP) of IETF.

The E-QAM 120 may receive traffic from the M-CMTS core 110 and the video server 150, multiplex the received traffic into various traffic combinations, and transfer the received traffic to a single wired QAM channel 170 having a uniform transfer rate. The wired QAM channel 170 may be replaced by a wireless QAM channel 180 having merits such as ease of access network construction, and so on. When the wireless QAM channel 180 is used, the E-QAM 120 cannot maintain a uniform transfer rate as the wired QAM channel 170 does.

Traffic sources including the M-CMTS core 110 and the video server 150 transfer traffic to the E-QAM 120 using a protocol, e.g., the DEPI protocol, which uses open-loop flow control to prevent the overflow of a receive buffer used in the traffic multiplexing process. In other words, the respective traffic sources statically set up traffic transfer rates, at which traffic is output to the E-QAM 120, on the basis of the uniform output transfer rate of the wired QAM channel 170 and a traffic multiplexing combination configuration of the E-QAM 120.

A configuration of the DEPI protocol used between an M-CMTS core and an E-QAM in a conventional cable network and a session establishment process will be described below with reference to FIGS. 2 to 5C.

FIG. 2 is a block diagram conceptually showing the configuration of the DEPI protocol.

Referring to FIG. 2, an M-CMTS core 210 according to the DEPI protocol and an E-QAM 220 establish a control connection 230 used for exchanging control messages and a session 240 for transferring data. Here, the M-CMTS core 210 is mapped onto the E-QAM 220 one-to-one through the control connection 230, and thus can transfer and receive control messages.

When the control connection 230 is established, the M-CMTS core 210 is mapped onto one QAM channel 260 one-to-one through the session 240, and thus can transfer and receive data. In other words, the M-CMTS core 210 establishes the one control connection 230 together with the E-QAM 220 through a predetermined procedure of initially establishing the control connection 230 and establishes the session 240 together with each QAM channel 260 in the E-QAM 220 through the control connection 230.

In the process of establishing the session 240, at least one data transfer path is set up, which is referred to as a data flow 250. According to a data form transferred through the data flow 250, sessions may be classified into a DOCSIS MPEG transport (D-MPT) session and Packet Stream Protocol (PSP) session.

In the D-MPT session, only one data flow can be set up. And, the M-CMTS core 210 generates and transfers an MPEG2-TP through the D-MPT session. On the other hand, in the PSP session, at least one data flow can be configured according to the priority of data. And, the E-QAM 220 generates an MPEG2-TP through the PSP session.

The E-QAM 220 can multiplex and transfer incoming traffic using a buffer. The E-QAM 220 may have buffers having fixed sizes according to data flows, or have a buffer pool to dynamically allocate the buffer to respective data flows.

FIG. 3 illustrates the form of a control packet used for the DEPI protocol.

Referring to FIG. 3, the control packet uses a control packet form of L2TPv3 including a 14-byte Ethernet 802.3 header 310, a 4-byte Ethernet 802.1Q selective header 320, a 20-byte Internet Protocol version 4 (IPv4) header 330, an 8-byte UDP header 340, a 16-byte L2TPv3 control header 350, a variable-length list of Attribute-Value Pairs (AVPs) 360, and a 4-byte Cyclic Redundancy Check (CRC) code 370. This is because the DEPI protocol fundamentally conforms to L2TPv3.

Control packets are classified into those including a UDP header and those not including a UDP header. Control packets including a UDP header distinguish a session using the UDP header, and thus include the 8-byte UDP header 340 but do not include a 4-byte session identification (ID) 351 in the L2TPv3 control header 350. On the other hand, control packets not including a UDP header distinguish a session using a session ID, and thus do not include the 8-byte UDP header 340 but include the 4-byte session ID 351 in the L2TPv3 control header 350.

The L2TPv3 control header 350 includes a 1-bit type field 352 (which is set to 1 for a control message) indicating a packet type, a 1-bit length indication field 353 indicating that a length field is valid, a 1-bit sequence indication field 354 indicating that a sequence number field is valid, a 3-bit version field 355 indicating a protocol version, a 2-byte length field 356 indicating a length, a 4-byte control connection ID field 357 for distinguishing a control connection, a 2-byte sending sequence number (Ns) field 358, and a 2-byte received sequence number (Nr) field 359.

The AVP list 360 consists of at least one AVP used for configuring a control connection. One AVP includes a 1-bit mandatory (M) field 361 indicating the necessity of the AVP, a 1-bit hidden (H) field 362 indicating encryption of the AVP, a 10-bit length field 364 indicating the length of the AVP, a 2-byte vendor ID field 365 for distinguishing each vendor (a value of 4491 is used in a DEPI), a 2-byte attribute-type field 366 indicating the type of the AVP, and a variable-length attribute-value field 367 indicating the value of the AVP.

FIG. 4 is a flowchart showing a process of establishing a session using a control packet according to the DEPI protocol.

Referring to FIG. 4, an M-CMTS core 401 transfers an incoming-call-request (ICRQ) message 410 including AVPs, such as a message type, a serial number, etc., to the E-QAM 402, thereby requesting the E-QAM 402 to establish a session. The E-QAM 402 receiving the ICRQ message 410 transfers an Incoming-Call-Reply (ICRP) message 420 including AVPs, such as a message type, a local session ID, etc., to the M-CMTS core 401, thereby replying to the request. The M-CMTS core 401 receiving the reply transfers again an Incoming-Call-Connected (ICCN) message 430 reporting the completion of a connection to the E-QAM 402, thereby finishing session establishment.

FIGS. 5A, 5B and 5C illustrate AVPs used for establishing a session according to the DEPI protocol.

FIG. 5A illustrates a form of a DEPI resource allocation request AVP 510. Referring to FIG. 5A, an M field 511 that is a basic field of an AVP must be included in an ICRQ message, and thus is set to 1, and a length field 513 is set to 6+N. In addition, a vendor ID field 514 is set to 4491, an attribute-type field 515 is set to 2, and an attribute-value field 516 is set to a Per Hop Behavior (PHB) ID value indicating a traffic priority.

FIG. 5B illustrates a form of a DEPI resource allocation reply AVP 520. Referring to FIG. 5B, an M field 521 that is a basic field of an AVP must be included in an ICRP message, and thus is set to 1, and a length field 523 is set to 8+4*N. In addition, a vendor ID field 524 is set to 4491, an attribute-type field 525 is set to 2, and an attribute-value field 526 is set to a flow ID and a UDP destination port value for each PHB ID of the DEPI resource allocation request AVP 510.

FIG. 5C illustrates a form of an E-QAM capability AVP 530. Referring to FIG. 5C, an M field 531 that is a basic field of an AVP must be included in an ICRQ message, and thus is set to 1, and a length field 533 is set to 8. A vendor ID field 534 is set to 4491, an attribute-type field 535 is set to 6, and an attribute-value field 536 is set as an E-QAM capability field having a bit mask value for the function of an E-QAM. Bit 0 is a bit value indicating a function for generating a packet reporting a packet transmission delay. Bit 1 to bit 15 are unused and reserved bit values.

However, a conventional open-loop flow control method using a protocol, such as the DEPI protocol, restricts multiplexing of traffic. In particular, such a conventional open-loop flow control method is inefficient for multiplexing a variable-bit-rate video traffic from an M-CMTS core and a video server together with other traffic. In addition, when the E-QAM 120 transfers traffic using a wireless QAM channel, overflow or underflow may frequently occur due to the variable transfer rate of the wireless QAM channel, thus requiring active traffic flow control.

### SUMMARY OF THE INVENTION

The present invention is directed to a closed-loop flow control method of controlling a downstream traffic flow, capable of actively adjusting a traffic transfer rate by reporting buffer status for the data flow of an Edge-Quadrature Amplitude Modulator (E-QAM) to a traffic source.

One aspect of the present invention provides a method of controlling a flow of downstream traffic transferred to a modulator by a traffic source in a cable network headend, the method comprising the steps of: establishing a session with the modulator; transferring traffic to the modulator over the session; and receiving a buffer-status reporting message reporting status of a receive buffer from the modulator while transferring the traffic. The step of establishing a session may include the steps of: generating, at the traffic source, a report criterion message including a buffer-status reporting criterion; and transferring, at the traffic source, the generated report criterion message to the modulator.

Another aspect of the present invention provides a method of controlling a flow of downstream traffic transferred to a modulator by a traffic source in a cable network headend, the method comprising the steps of: transferring a buffer-status reporting request message to the modulator; and receiving a buffer-status reporting message generated in response to the buffer-status reporting request message from the modulator. The method may further comprise the steps of: after the step of receiving the buffer-status reporting message, generating, at the traffic source, a buffer-status reporting reply message including a buffer-status reporting criterion; and transferring, at the traffic source, the buffer-status reporting reply message to the modulator.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram conceptually showing the structure of a headend in a cable network;

FIG. 2 is a block diagram conceptually showing the configuration of a Downstream External Physical layer (PHY) Interface (DEPI) protocol;

FIG. 3 illustrates the form of a control packet used for the DEPI protocol;

FIG. 4 is a flowchart showing a process of establishing a session using a control packet according to the DEPI protocol;

FIGS. 5A, 5B and 5C illustrate Attribute-Value Pairs (AVPs) used for establishing a session according to the DEPI protocol;

FIGS. 6A and 6B illustrate forms of an additional AVP for buffer-status reporting criteria according to an exemplary embodiment of the present invention;

FIG. 7 is a flowchart showing a process of establishing a session using a control packet including an additional AVP according to an exemplary embodiment of the present invention;

FIG. 8 is a flowchart showing a process of requesting and replying to a buffer-status report according to an exemplary embodiment of the present invention; and

FIGS. 9A, 9B and 9C illustrate forms of data packets transferred using the DEPI protocol according to an exemplary embodiment of the present invention.

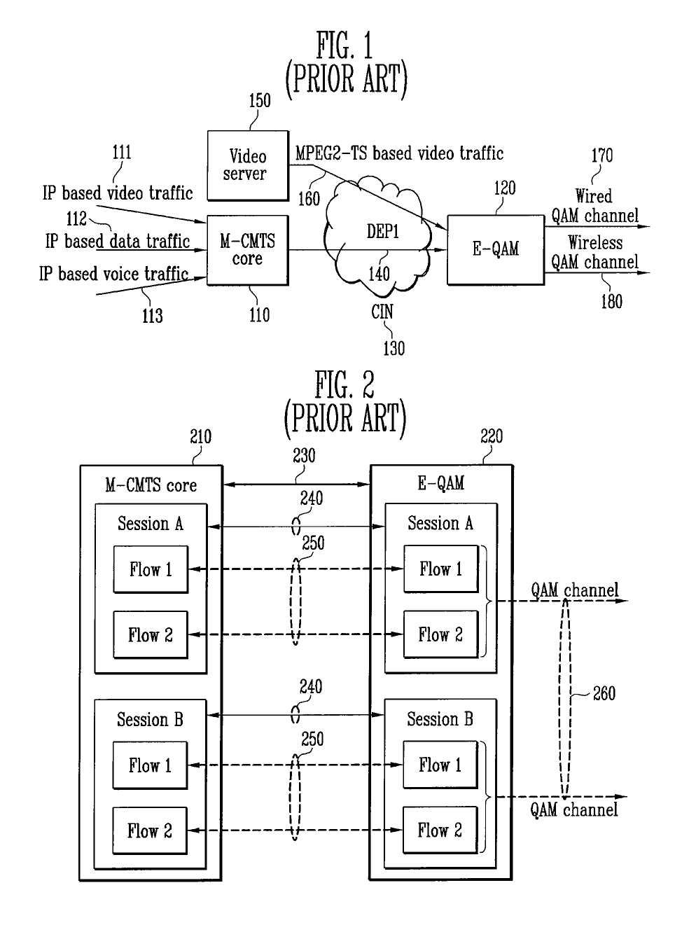

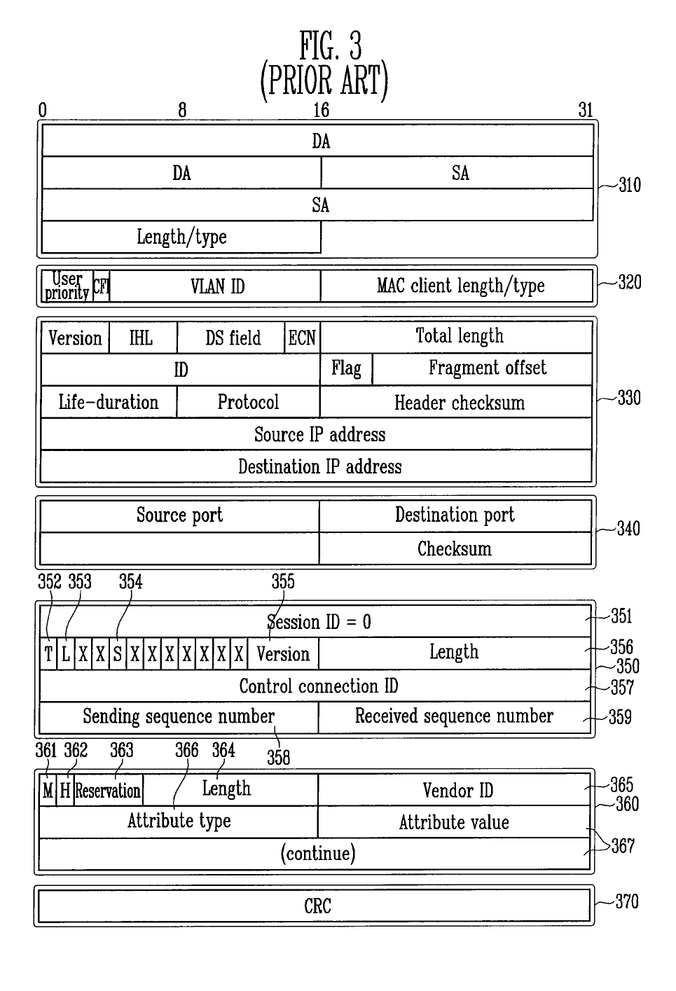

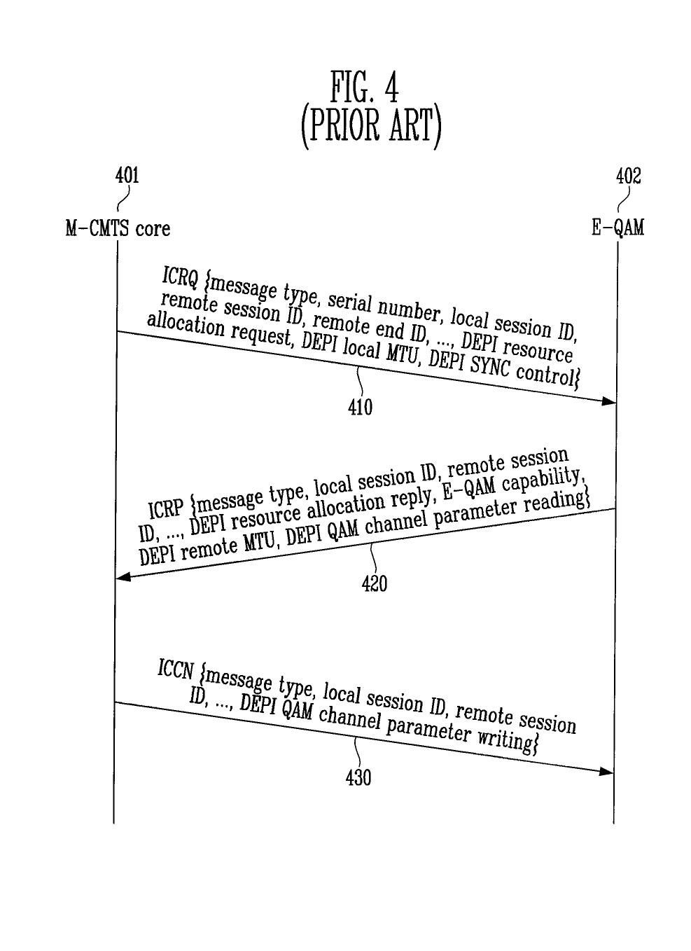

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

FIGS. 6A and 6B illustrate forms of an additional Attribute-Value Pair (AVP) for buffer-status reporting criteria according to an exemplary embodiment of the present invention.

FIG. 6A illustrates the form of a Downstream External PHY Interface (DEPI) buffer-status reporting criteria AVP 610 denoting criteria whereby buffer status for all data flows of the corresponding session is reported.

Referring to FIG. 6A, the DEPI buffer-status reporting criteria AVP 610 includes a mandatory (M) field 611 set to 1, a length field 613 set to 14, a vendor identification (ID) field 614 set to 4491, and an attribute-type field 615 set to 21. In addition, an attribute value field 616 may include 3 criterion values whereby buffer status for all data flows of a session is reported.

As a first criterion value, an 8-bit buffer occupancy threshold value is set within a range between 1 and 100%. When the occupancy of a buffer of a specific section reaches the buffer occupancy threshold value, an Edge-Quadrature Amplitude Modulator (E-QAM) reports buffer status for all data flows of a session to a modularized Cable Modem Termination System (M-CMTS) core.

As a second criterion value, a 16-bit buffer-status reporting timer is set within a range between 1 and 65535 milliseconds (ms). The E-QAM drives a timer using the buffer-status reporting timer value when traffic is initially received after session establishment. Afterwards, every time the timer is triggered, the E-QAM reports buffer status for all the data flows of the session to the M-CMTS core and drives the timer again.

A third criterion value is a 16-bit number of received Moving Picture Experts Group (MPEG)-Transport Stream (TS) packets or segments. When the number of received MPEG-TS packets or segments of all data flows included in the same session reaches the number of received MPEG-TS packets or segments, i.e., the third criterion value, the E-QAM reports buffer status for all the data flows of the corresponding session to the M-CMTS core and initializes the number of received packets or segments.

FIG. 6B illustrates the form of a DEPI buffer-status reporting AVP reporting buffer status for all data flows of a session.

Referring to FIG. 6B, a DEPI buffer-status reporting AVP 620 includes an M field 621 set to 1, a length field 623 set to 6+6*N, a vendor ID field 624 set to 4491, and an attribute-type field 625 set to 22. In addition, an attribute-value field 626 includes a 3-bit flow ID value for identifying a data flow in a session, a 24-bit free buffer size field denoting a free space size of a buffer for a data flow having the flow ID value, and a maximum sequence number of a received DEPI payload stored in the buffer.

Using the additional AVPs, the M-CMTS core sets up a buffer-status reporting criterion and transfers it to the E-QAM, and the E-QAM may report buffer status on the basis of the criterion or at uniform periods.

FIG. 7 is a flowchart showing a process of establishing a session using a control packet including an additional AVP according to an exemplary embodiment of the present invention.

Referring to FIG. 7, at the beginning, an M-CMTS core 701 transfers an incoming-call-request (ICRQ) message 710 to an E-QAM 702, thereby requesting session establishment. Here, the ICRQ message 710 includes a DEPI resource allocation request AVP including a plurality of 6-bit Per Hop Behavior (PHB) values.

The E-QAM 702 receiving the ICRQ message 710 transfers an Incoming-Call-Reply (ICRP) message including a DEPI resource allocation reply AVP in response to the DEPI resource allocation request AVP in the ICRQ message 710. Here, the DEPI resource allocation reply AVP includes flow IDs and User Datagram Protocol (UDP) port numbers allocated to all PHB IDs requested by the M-CMTS core 701.

The M-CMTS core 701 receiving the ICRP message 720 can recognize the number of flows set to a value in the DEPI resource allocation reply AVP in the ICRP message 720. The M-CMTS core 701 generates a buffer-status reporting criteria AVP on the basis of the number of flows and transfers an Incoming-Call-Connected (ICCN) message 730 including the buffer-status reporting criteria AVP, thereby completing session establishment.

The E-QAM 702 receiving the ICCN message 730 sets up a buffer-status reporting criterion according to the buffer-status reporting criteria AVP included in the ICCN message 730, and then reports buffer status according to the set criterion. Through the above-described session establishment procedure, the M-CMTS core 701 can transfer the buffer-status reporting criterion to the E-QAM 702.

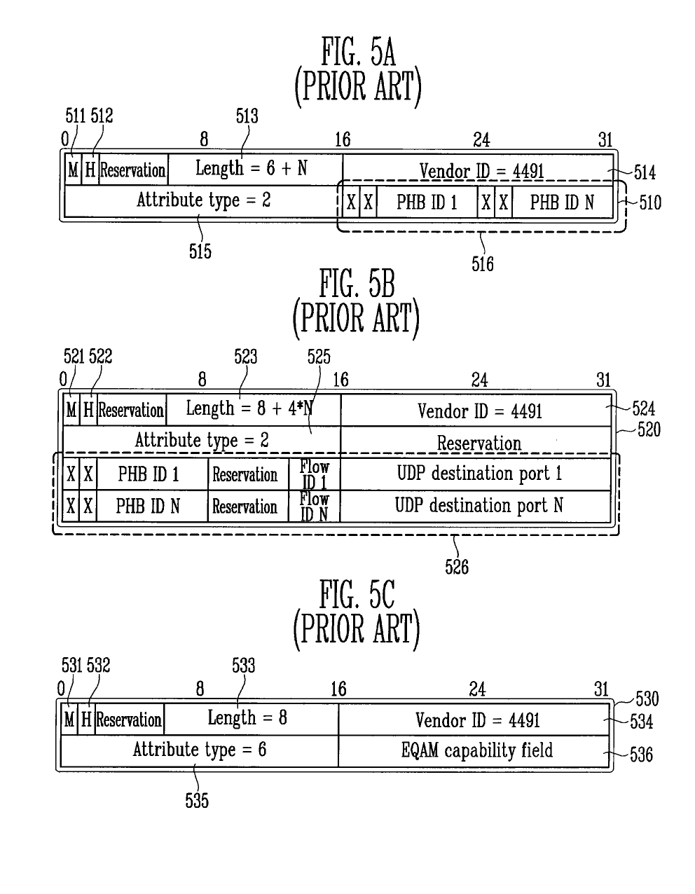

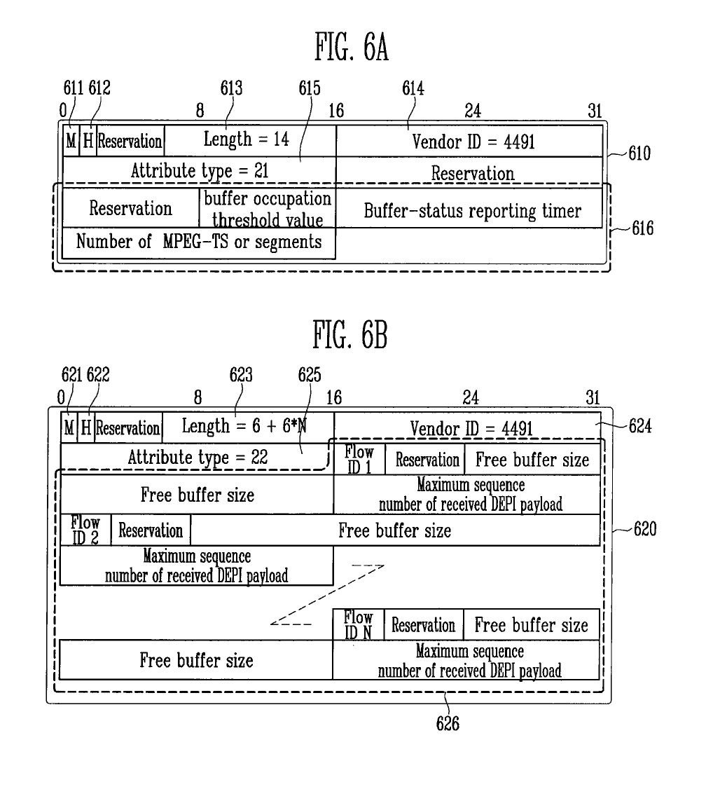

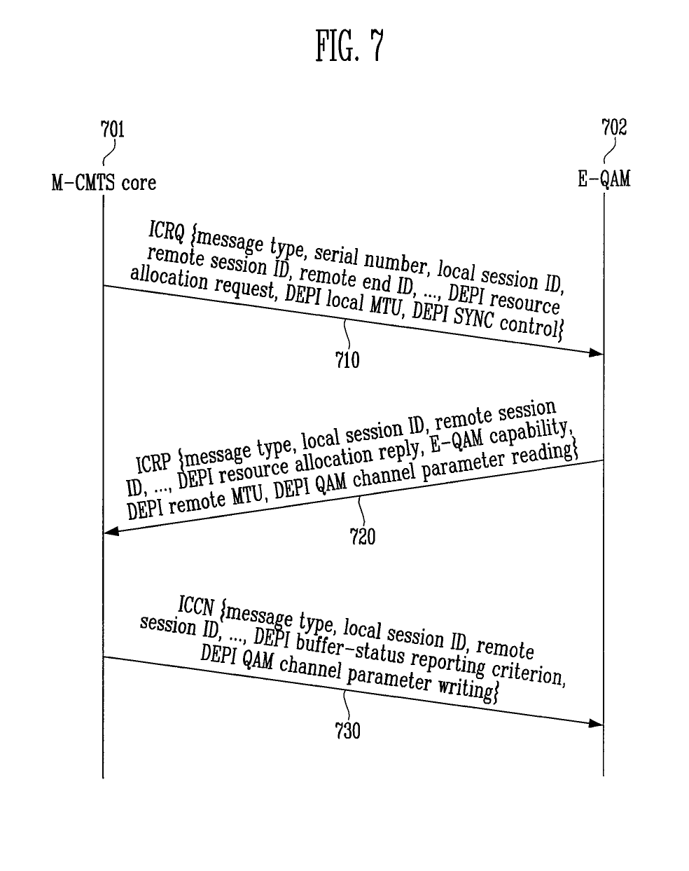

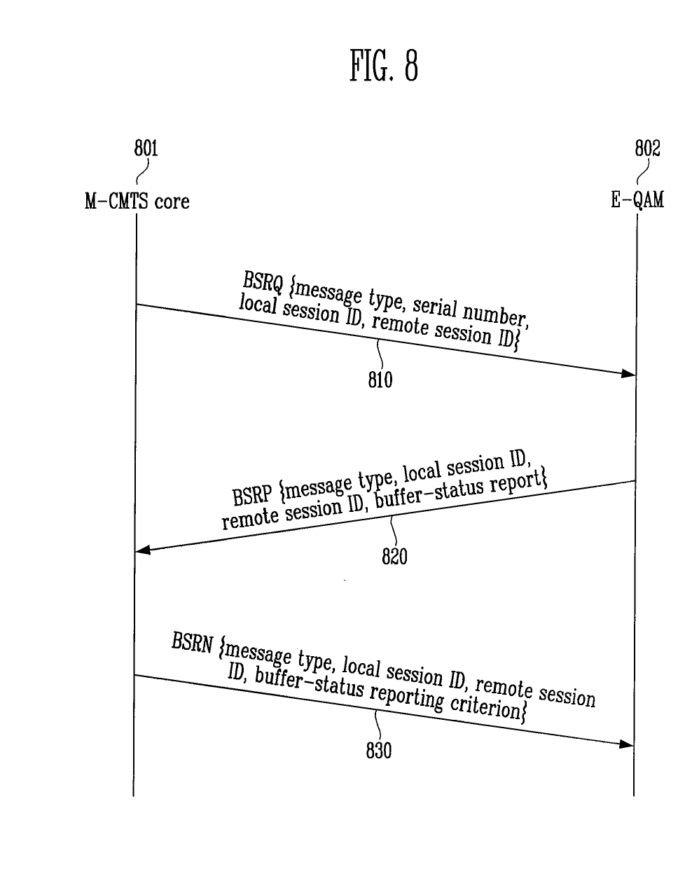

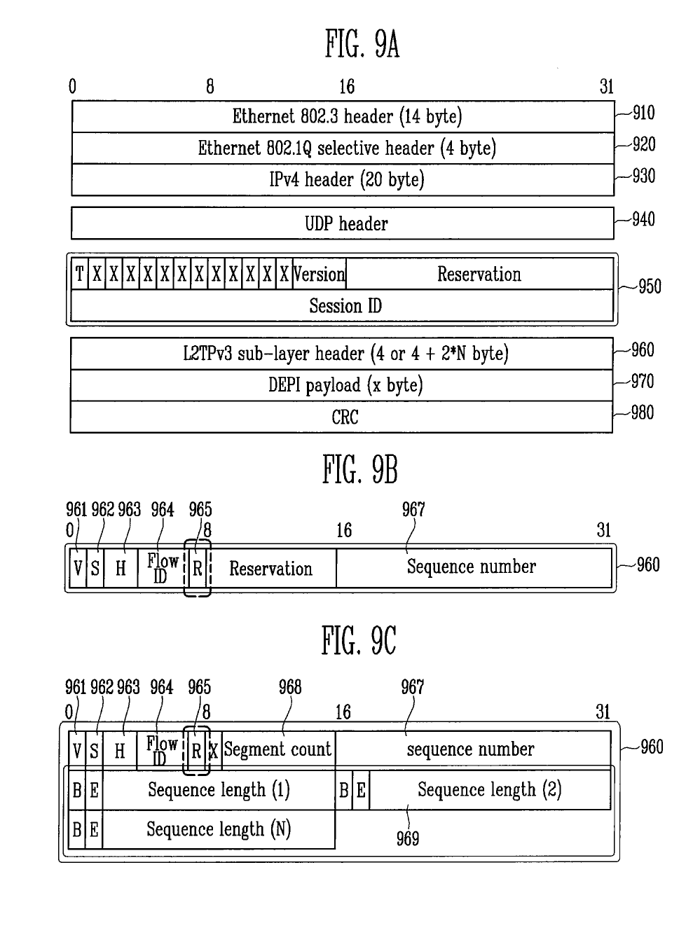

According to an exemplary embodiment of the present invention, there are 2 methods of reporting buffer status. One reports the buffer status depending on a buffer-status reporting request of an M-CMTS core, and the other reports the buffer status according to a bit value set up in the header of a data packet transferred from the M-CMTS to an E-QAM. The additional reporting methods will be described below with reference to Table 1 and FIGS. 8 to 9C.

TABLE 1

| Message | | | |
|---|---|---|---|
| Type | Mnemonic | Name | From-to |
| 1 | BSRQ | Buffer-Status Reporting | M-CMTS core → |
| | | Request | E-QAM |
| 2 | BSRP | Buffer-Status Reporting | E-QAM → M- |
| | | Reply | CMTS core |
| 3 | BSRN | Buffer-Status Reporting | M-CMTS core → |
| | | Notify | E-QAM |

Table 1 shows additional messages associated with the method of reporting buffer status in response to the request of an M-CMTS core according to an exemplary embodiment of the present invention.

Referring to Table 1, a BSRQ message is transferred from the M-CMTS core to an E-QAM to request a buffer-status report, and a BSRP message is transferred from the E-QAM to the M-CMTS core to report buffer status. A BSRN message is transferred from the M-CMTS core to the E-QAM in response to the BSRP message.

FIG. 8 is a flowchart showing a process of requesting and replying to a buffer-status report according to an exemplary embodiment of the present invention.

Referring to FIG. 8, an M-CMTS core 801 transfers a BSRQ message 810 to an E-QAM 802, thereby requesting the E-QAM 802 to report buffer status for all data flows of an established session. Here, the BSRQ message 810 includes a message type AVP denoting that it is the BSRQ message 810, a serial number AVP for the message, a local session ID AVP denoting a session ID used by the M-CMTS core 801, and a remote session ID AVP denoting a session ID used by the E-QAM 802.

On the basis of the remote session ID AVP in the BSRQ message 810, the E-QAM 802 receiving the BSRQ message 810 generates a BSRP message 820 including a buffer-status reporting AVP in which buffer status according to data flows of the corresponding session is recorded, and transfers it to the M-CMTS core 801.

The M-CMTS core 801 receiving the BSRP message 820 recognizes the buffer status of each data flow using the buffer-status reporting AVP in the BSRP message 820, and controls the flow of traffic transferred to the E-QAM 802 on the basis of the buffer status of each data flow.

The M-CMTS core 801 transfers a BSRN message 830 to the E-QAM 802 in response to the BSRP message 820, thereby completing a buffer-status reporting procedure.

Here, the BSRN message 830 may include a buffer-status reporting criteria AVP whereby a criterion for a buffer-status report is reset. Thus, when a buffer-status reporting criteria AVP is included in the received BSRN message 830, the E-QAM 802 resets a buffer-status reporting criterion for each data flow and then reports buffer status according to the set criterion.

In an exemplary embodiment, the E-QAM 802 may generate and transfer the BSRP message 820 to the M-CMTS core 801 in response to the request by the BSRQ message 810 according to buffer-status reporting criteria set by the ICCN message 730 or the BSRN message 830. In response to the BSRP message 820, as described above, the M-CMTS core 801 may generate and transfer the BSRN message 830 including the new buffer-status reporting criterion.

FIGS. 9A, 9B and 9C illustrate forms of data packets transferred using the DEPI protocol according to an exemplary embodiment of the present invention.

Referring to FIG. 9A, the form of a data packet includes a 14-byte Ethernet 802.3 header 910, a 4-byte Ethernet 802.1Q selective header 920, a 20-byte Internet Protocol version 4 (IPv4) header 930, a 8-byte UDP header 940, a 4 or 8-byte Layer 2 Tunneling Protocol version 3 (L2TPv3) data header 950, a 4 or (4+2*N)-byte L2TPv3 sub-layer header 960, and a 4-byte Cyclic Redundancy Check (CRC) code 980.

Data packets are classified into those including a UDP header and those not including a UDP header. Control packets including a UDP header distinguish a session using the UDP header, and thus include the 8-byte UDP header 940 but do not include a 4-byte session ID in the L2TPv3 data header 950. On the other hand, control packets not including a UDP header distinguish a session using a session ID, and thus do not include the 8-byte UDP header 940 but include a 4-byte session ID in the L2TPv3 data header 950.

The L2TPv3 sub-layer header 960 in a data packet is constituted differently according to the type of the data packet. FIGS. 9B and 9C illustrate the forms of the L2TPv3 sub-layer header 960 of data packets used in the above-described Data Over Cable Service Interface Specification (DOCSIS) MPEG transport (D-MPT) session and Packet Stream Protocol (PSP) session, respectively. Referring to FIGS. 9B and 9C, using an unused 1 bit disposed next to a flow ID field 964 as a Reporting (R) bit mask field 965, an E-QAM may report buffer status of a data flow. In other words, when the E-QAM receives a data packet in which the R field 965 of the L2TPv3 sub-layer header 960 is set to 1, it may report buffer status of a data flow whereto the data packet belongs.

The present invention reports buffer-status information of an E-QAM to a traffic source, thereby enabling control of the transfer rate of traffic transferred from the traffic source to the E-QAM and preventing overflow/underflow of a receive buffer, packet loss and deterioration of channel use.

In addition, the present invention provides a method of reporting buffer-status information of an E-QAM to a traffic source, thereby allowing flexibility of selecting a reporting criterion according to traffic flow control policy.

In addition, the present invention provides a method for a traffic source to request a buffer-status report using a request message or a field of a data packet, and thus can rapidly cope with a situation, such as overflow/underflow of a buffer.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of controlling a flow of downstream traffic transferred to a modulator by a traffic source in a cable network headend, the method comprising the steps of:
(a) establishing a session with the modulator;
(b) transferring traffic to the modulator over the session; and
(c) receiving a buffer-status reporting message reporting the status of a receive buffer from the modulator while transferring the traffic.

2. The method of claim 1, wherein step (a) comprises the steps of:
(a1) generating, at the traffic source, a reporting criterion message including a buffer-status reporting criterion; and
(a2) transferring, at the traffic source, the generated reporting criterion message to the modulator.

3. The method of claim 2, wherein in step (c), the traffic source receives the buffer-status reporting message according to the buffer-status reporting criterion included in the reporting criterion message.

4. The method of claim 2, wherein the buffer-status reporting criterion comprises at least one of an occupancy of the receive buffer, an amount of traffic received over the session, and expiration of uniform time periods.

5. The method of claim 1, wherein the buffer-status reporting message comprises a report on status of the receive buffer for each data flow in the session.

6. The method of claim 1, wherein the buffer-status reporting message comprises at least one of a free space size of the receive buffer and a maximum sequence number of a payload stored in the receive buffer.

7. A method of controlling a flow of downstream traffic received from a traffic source by a modulator in a cable network headend, the method comprising the steps of:
(a) establishing a session with the traffic source;
(b) receiving traffic from the traffic source over the session; and
(c) transferring a buffer-status reporting message reporting the status of a receive buffer to the traffic source while receiving the traffic.

8. The method of claim 7, wherein step (a) comprises the step of:
receiving, at the modulator, a reporting criterion message including a buffer-status reporting criterion from the traffic source.

9. The method of claim 8, wherein in step (c), the modulator transfers the buffer-status reporting message according to the buffer-status reporting criterion included in the reporting criterion message.

10. The method of claim 8, wherein the buffer-status reporting criterion comprises at least one of an occupancy of the receive buffer, an amount of traffic received over the session, and expiration of uniform time periods.

11. The method of claim 7, wherein the buffer-status reporting message comprises a report on status of the receive buffer for each data flow in the session.

12. The method of claim 7, wherein the buffer-status reporting message comprises at least one of a free space size of the receive buffer and a maximum sequence number of a payload stored in the receive buffer.

13. A method of controlling a flow of downstream traffic transferred to a modulator by a traffic source in a cable network headend, the method comprising the steps of:
(a) transferring a buffer-status reporting request message to the modulator; and
(b) receiving a buffer-status reporting message generated in response to the buffer-status reporting request message from the modulator.

14. The method of claim 13, after step (b), further comprising the steps of:
(c) generating, at the traffic source, a buffer-status reporting reply message including a buffer-status reporting criterion; and
(d) transferring, at the traffic source, the buffer-status reporting reply message to the modulator.

15. The method of claim 14, wherein the buffer-status reporting criterion comprises at least one of an occupancy of a receive buffer, an amount of traffic received over a session, and expiration of uniform time periods.

16. The method of claim 13, wherein the buffer-status reporting message comprises a report on status of a receive buffer for each data flow in a session.

17. The method of claim 13, wherein the buffer-status reporting message comprises at least one of a free space size of a receive buffer and a maximum sequence number of a payload stored in the receive buffer.

18. A method of controlling a flow of downstream traffic received from a traffic source by a modulator in a cable network headend, the method comprising the steps of:
(a) receiving a buffer-status reporting request message from the traffic source;
(b) generating a buffer-status reporting message reporting the status of a receive buffer in response to the buffer-status reporting request message; and
(c) transferring the buffer-status reporting message to the traffic source.

19. The method of claim 18, after step (c), further comprising the step of:
receiving, at the modulator, a buffer-status reporting reply message including a buffer-status reporting criterion from the traffic source.

20. The method of claim 19, wherein the buffer-status reporting criterion comprises at least one of an occupancy of the receive buffer, an amount of traffic received over a session, and expiration of uniform time periods.

21. The method of claim 18, wherein the buffer-status reporting message comprises a report on status of the receive buffer for each data flow in a session.

22. The method of claim 18, wherein the buffer-status reporting message comprises at least one of a free space size of the receive buffer and a maximum sequence number of a payload stored in the receive buffer.

23. A method of controlling a flow of downstream traffic received from a traffic source by a modulator in a cable network headend, the method comprising the step of:
(a) receiving a data packet from the traffic source;
(b) generating a buffer-status reporting message reporting the status of a receive buffer in response to a reporting bit mask field of the data packet;
(c) transferring the buffer-status reporting message to the traffic source.

24. The method of claim 23, where in the buffer-status reporting message comprises a report on status of the receive buffer for each data flow in a session.

25. The method of claim 23, wherein the buffer-status reporting message comprises at least one of a free space size of the receive buffer and a maximum sequence number of a payload stored in the receive buffer.
